(19) United States
(12) Patent Application Publication
(10) Pub. No.: US 2026/0163597 A1
(43) Pub. Date: Jun. 11, 2026

(54) SIGNAL RECEPTION

(71) Applicant: Nokia Technologies OY, Espoo (FI)

(72) Inventors: Kim NIELSEN, Storvorde (DK); Petri Juhani VASENKARI, Turku (FI); Johannes HEJSELBAEK, Holstebro (DK); Man Hung NG, Swindon (GB); Tuomo Mikael SÄYNÄJÄKANGAS, Oulu (FI)

(73) Assignee: Nokia Technologies OY, Espoo (FI)

(21) Appl. No.: 19/173,988

(22) Filed: Apr. 9, 2025

(30) Foreign Application Priority Data
Jun. 28, 2024 (GB) 2409373.4

(51) Int. Cl. H04B 1/10; H04B 7/0413

(52) U.S. Cl. CPC H04B 1/1027; H04B 7/0413

(57) ABSTRACT

In one embodiment, an apparatus may perform receiving signals across a frequency range in a first mode, the frequency range containing at least two non-contiguous frequency blocks separated by at least one frequency block in which unwanted signals may be transmitted; in the first mode using at least two receive branches; and receiving signals across the frequency range in a second mode using one receive branch to receive a first frequency block of the at least two non-contiguous frequency blocks and suppress reception of a signal in the at least one frequency block in which unwanted signals may be transmitted; and another of the receive branches of at least two receive branches to receive a different frequency block of the at least two non-contiguous frequency blocks and suppress reception of a signal in the at least one frequency block in which unwanted signals may be transmitted.

### TECHNOLOGICAL FIELD

Various example embodiments relate to signal reception.

### BACKGROUND

User equipment may be configured to receive signals transmitted by a network node in a wireless communication network. The user equipment may receive unwanted signals that were not transmitted by the network node. It would be desirable to mitigate the effects of such unwanted signals.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to some, but not necessarily all, embodiments there is provided: an apparatus comprising:
at least one processor; and
at least one memory storing instructions that when executed by the at least one processor cause the apparatus at least to perform:
   receiving signals, from a network node, across a frequency range in a first mode, the frequency range containing at least two non-contiguous frequency blocks containing wanted signals for receiving signals transmitted by the network node, the at least two non-contiguous frequency blocks being separated by at least one frequency block in which unwanted signals to the apparatus may be transmitted; the apparatus being configured in the first mode to use at least two receive branches configured to receive signals across the first frequency range;
   receiving signals, from the network node, across the frequency range in a second mode, the frequency range; the apparatus being configured in the second mode to use one receive branch of the at least two receive branches to receive a first frequency block of the at least two non-contiguous frequency blocks containing a wanted signal and suppress reception of a signal in the at least one frequency block in which unwanted signals to the apparatus may be transmitted; and another of the receive branches of at least two receive branches to receive a different frequency block of the at least two non-contiguous frequency blocks containing a wanted signal and suppress reception of a signal in the at least one frequency block in which unwanted signals to the apparatus may be transmitted;
   determining an indication that the apparatus is to change between the first mode and the second mode; and
   adjusting the apparatus between the first mode and the second mode in response to determining the indication that the apparatus is to change between modes.

According to some, but not necessarily all, embodiments there is provided an apparatus comprising:
means for receiving signals, from a network node, across a frequency range in a first mode, the frequency range containing at least two non-contiguous frequency blocks containing wanted signals for receiving signals transmitted by the network node, the at least two non-contiguous frequency blocks being separated by at least one frequency block in which unwanted signals to the apparatus may be transmitted; the apparatus being configured in the first mode to use at least two receive branches configured to receive signals across the first frequency range;
means for receiving signals, from the network node, across the frequency range in a second mode, the frequency range; the apparatus being configured in the second mode to use one receive branch of the at least two receive branches to receive a first frequency block of the at least two non-contiguous frequency blocks containing a wanted signal and suppress reception of a signal in the at least one frequency block in which unwanted signals to the apparatus may be transmitted; and another of the receive branches of at least two receive branches to receive a different frequency block of the at least two non-contiguous frequency blocks containing a wanted signal and suppress reception of a signal in the at least one frequency block in which unwanted signals to the apparatus may be transmitted;
means for determining an indication that the apparatus is to change between the first mode and the second mode; and
means for adjusting the apparatus between the first mode and the second mode in response to determining the indication that the apparatus is to change between modes.

The means may perform the optional features set out in relation to an apparatus as mentioned above.

According to some, but not necessarily all, embodiments there is provided an apparatus comprising:
circuitry configured to receive signals, from a network node, across a frequency range in a first mode, the frequency range containing at least two non-contiguous frequency blocks containing wanted signals for receiving signals transmitted by the network node, the at least two non-contiguous frequency blocks being separated by at least one frequency block in which unwanted signals to the apparatus may be transmitted; the apparatus being configured in the first mode to use at least two receive branches configured to receive signals across the first frequency range;
circuitry configured to receive signals, from the network node, across the frequency range in a second mode, the frequency range; the apparatus being configured in the second mode to use one receive branch of the at least two receive branches to receive a first frequency block of the at least two non-contiguous frequency blocks containing a wanted signal and suppress reception of a signal in the at least one frequency block in which unwanted signals to the apparatus may be transmitted; and another of the receive branches of at least two receive branches to receive a different frequency block of the at least two non-contiguous frequency blocks containing a wanted signal and suppress reception of a signal in the at least one frequency block in which unwanted signals to the apparatus may be transmitted;
circuitry configured to determine an indication that the apparatus is to change between the first mode and the second mode; and
circuitry configured to adjust the apparatus between the first mode and the second mode in response to determining the indication that the apparatus is to change between modes.

The circuitry may be configured perform the optional features set out in relation an apparatus as mentioned above.

According to some, but not necessarily all, embodiments there is provided a method performed by user equipment, the method comprising:
receiving signals, from a network node, across a frequency range in a first mode, the frequency range containing at least two non-contiguous frequency blocks for receiving signals transmitted by the network node, the at least two non-contiguous frequency blocks being separated by at least one frequency block in which unwanted signals may be transmitted; the apparatus being configured in the first mode to use at least two receive branches configured to receive signals across the first frequency range;
receiving signals, from the network node, across the frequency range in a second mode, the frequency range; the apparatus being configured in the second mode to use one receive branch of the at least two receive branches to receive a first frequency block of the at least two non-contiguous frequency blocks and suppress reception of a signal in the at least one frequency block in which unwanted signals may be transmitted; and another of the receive branches of at least two receive branches to receive a different frequency block of the at least two non-contiguous frequency blocks and suppress reception of a signal in the at least one frequency block in which unwanted signals may be transmitted;
determining an indication that the apparatus is to change between the first mode and the second mode; and
adjusting the apparatus between the first mode and the second mode in response to determining the indication that the apparatus is to change between the first mode and the second mode.

According to some, but not necessarily all, embodiments there is provided a computer program comprising instructions which, when executed by an apparatus, cause the apparatus to perform at least the following:
receiving signals, from a network node, across a frequency range in a first mode, the frequency range containing at least two non-contiguous frequency blocks for receiving signals transmitted by the network node, the at least two non-contiguous frequency blocks being separated by at least one frequency block in which unwanted signals may be transmitted; the apparatus being configured in the first mode to use at least two receive branches configured to receive signals across the first frequency range;
receiving signals, from the network node, across the frequency range in a second mode, the frequency range; the apparatus being configured in the second mode to use one receive branch of the at least two receive branches to receive a first frequency block of the at least two non-contiguous frequency blocks and suppress reception of a signal in the at least one frequency block in which unwanted signals may be transmitted; and another of the receive branches of at least two receive branches to receive a different frequency block of the at least two non-contiguous frequency blocks and suppress reception of a signal in the at least one frequency block in which unwanted signals may be transmitted;
determining an indication that the apparatus is to change between the first mode and the second mode; and
adjusting the apparatus between the first mode and the second mode in response to determining the indication that the apparatus is to change between the first mode and the second mode.

A non-transitory computer readable medium comprising program instructions stored thereon for performing at least the following:
receiving signals, from a network node, across a frequency range in a first mode, the frequency range containing at least two non-contiguous frequency blocks for receiving signals transmitted by the network node, the at least two non-contiguous frequency blocks being separated by at least one frequency block in which unwanted signals may be transmitted; the apparatus being configured in the first mode to use at least two receive branches configured to receive signals across the first frequency range;
receiving signals, from the network node, across the frequency range in a second mode, the frequency range; the apparatus being configured in the second mode to use one receive branch of the at least two receive branches to receive a first frequency block of the at least two non-contiguous frequency blocks and suppress reception of a signal in the at least one frequency block in which unwanted signals may be transmitted; and another of the receive branches of at least two receive branches to receive a different frequency block of the at least two non-contiguous frequency blocks and suppress reception of a signal in the at least one frequency block in which unwanted signals may be transmitted;
determining an indication that the apparatus is to change between the first mode and the second mode; and
adjusting the apparatus between the first mode and the second mode in response to determining the indication that the apparatus is to change between the first mode and the second mode.

The instructions may be for performing the optional features set out in relation to the method mentioned above.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

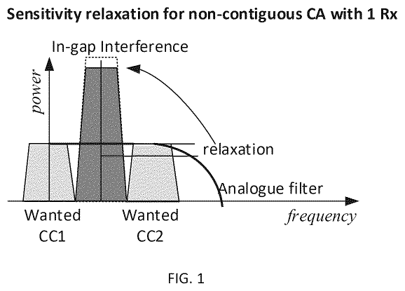

FIG. 1 illustrates relaxation of an in-gap interferers level signal level;

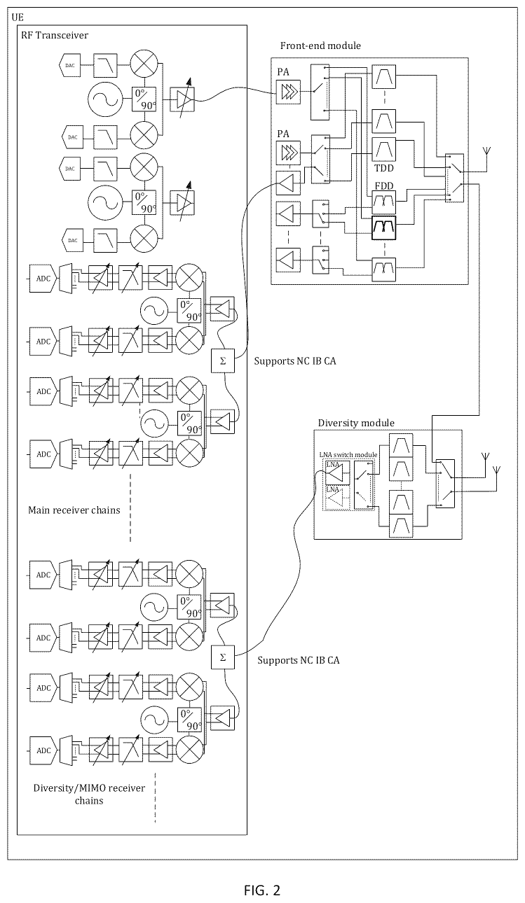

FIG. 2 illustrates schematically a typical UE radio frequency architecture;

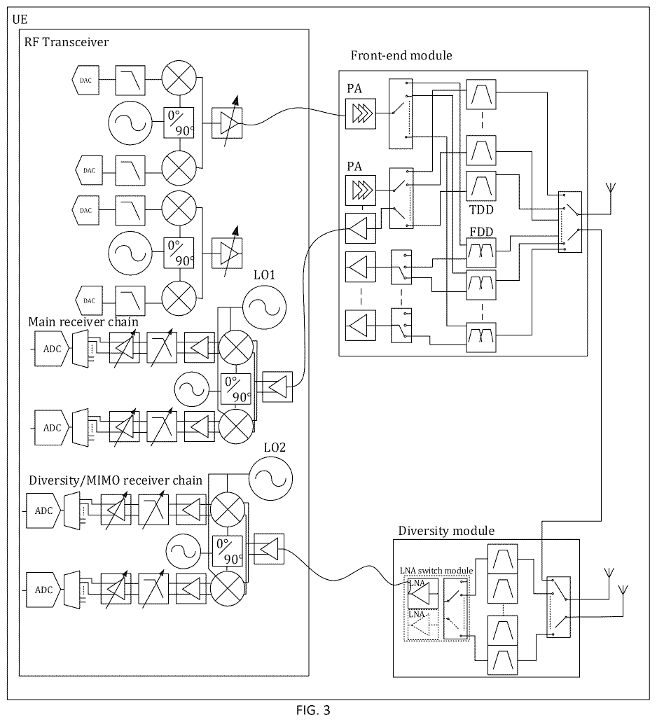

FIG. 3 is a simplified schematic illustration of a UE radio frequency architecture according to an arrangement;

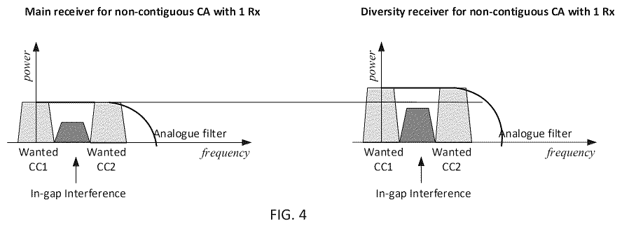

FIG. 4 is a graphic illustration of reception at baseband frequency at a UE configured to use diversity methods if a signal-to-in-gap interference ratio (SIG) is determined to be below a threshold;

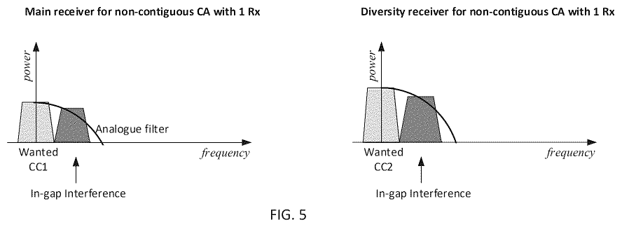

FIG. 5 is a graphic illustration of reception at baseband frequency at a UE configured to use split local oscillator frequency assignment with a single component carrier analogue bandwidth if a signal-to-in-gap interference ratio (SIG) is determined to be above a threshold;

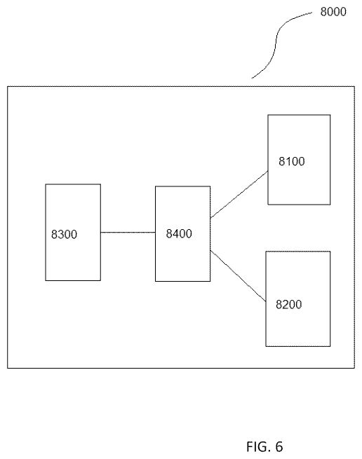

FIG. 6 illustrates schematically an apparatus according to an arrangement; and

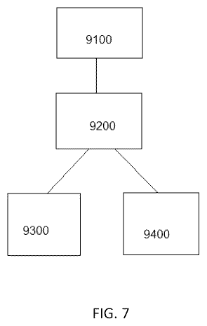

FIG. 7 illustrates schematically a method according to an arrangement.

### DETAILED DESCRIPTION

Before discussing the example embodiments in any more detail, first an overview will be provided.

The frequency spectrum for wireless communication systems is split into a plurality of frequency bands, for example, 5G and LTE bands. These frequency bands are typically split into a plurality of channels (also referred to as frequency blocks or carriers). Each channel may be licensed to a particular operator. A conventional receiver of a user equipment (UE) comprises a band filter configured to pass signals within a desired frequency band. The UE further comprises a channel filter configured to pass signals within the channel that is licensed to the operator of the network which the user equipment belongs to.

In some scenarios, the channel filter of the user equipment may pass some frequencies which are not reserved for their operator. In this case, unwanted signals may be received which can degrade the quality of the received wanted signals. For example, where the operator occupies non-contiguous carriers being separated by a carrier occupied by another operator, if the user equipment has a single channel filter covering all of the carriers of their operator, signals on the intervening carrier may cause interference at the user equipment. One solution to this problem is implementing two channel filters at the user equipment. One channel filter passes signals received in a first set of frequency blocks licensed to the operator and a second channel filter passes signals received in a second set of frequency blocks licensed to the operator. In this way, the UE can avoid receiving the unwanted signals on the intervening carrier. However, this solution typically requires additional hardware in the UE which could have been used for receiving additional carriers in other bands licensed by an operator. Embodiments aim to overcome the above-identified problem without requiring the addition of significant hardware in a UE.

Embodiments recognise that a UE can be enabled to sacrifice diversity gain in a non-contiguous intra-band carrier aggregation configuration and utilize its diversity receive branch, together with another receive branch, each operating at different centre frequencies to suppress unwanted signals. Such a reconfiguration can allow a UE to apply appropriately selected analogue filters, selected to match or map to individual frequency blocks (each frequency block contains one or more component carrier (CC)) of the configuration). Such a configuration may also allow for attenuation of an in-gap interferer, by treating it as if it were adjacent channel interference to be suppressed.

Embodiments recognise that the sacrifice of gain an additional receiver branch such as a diversity receive branch means that a UE may, for example, lose up to 3 dB diversity gain, but that such a 3 dB loss in gain may be negligible compared to implementing relaxed requirements which support use of one receive branch to receive 2 component carriers and an in-gap interferer.

In some embodiments, a UE may also be enabled to toggle between a first “standard mode” of operation according to which use of a diversity receive branch operating at the same frequency as a main receive branch, when the UE detects the in-gap interference is at a tolerable level, and a second “non-contiguous reception mode” in which the UE operates to sacrifice diversity gain and “split” the main and diversity receive branches, for example, when the UE detects the in-gap interference is at an intolerable level.

It will, of course, be appreciated that if a UE is configured to use a diversity receiver for reception of another frequency block (each frequency block contains one or more component carrier) then UE MIMO capability is reduced. By way of example, a 2-Layer MIMO UE could become a non-MIMO UE; a 4-layer MIMO UE could become a 2-layer MIMO UE.

In other words, embodiments may mitigate intra-band interference by utilising a diversity receive branch for straight reception operating at a centre frequency different to that of a main receive branch, rather than to augment the main receive branch by having a centre frequency identical to that of the diversity receive branch. Some embodiments may support switching between a first mode, in which the UE is configured to receive signals across the full frequency range of the frequency blocks licensed to the operator (encompassing the intervening channel). In such a case, the main and diversity receive branches may be configured such that they have the same centre frequency. If operating in a dynamic mode, the UE monitors for signs indicative that unwanted signals within the intervening channel are causing an intolerable level of interference at which point the UE can be adjusted to operate in a second mode in which a primary and at least one diversity receive branch are configured such that each branch operates at a different centre frequency and therefore mitigate an interference signal in frequency blocks, thereby effectively excluding an intervening channel containing the unwanted signals. In this mode, the UE may receive signals with less interference. If operating in dynamic mode, if or when the level of interference reduces to a tolerable level, the UE may switch back to the first mode such that signals can be received from the network over the entire frequency range, and in which the main and diversity receive branches have the same centre frequencies. In this way, a UE may operate over non-contiguous channels without the need for channel filters explicitly assigned to each frequency block.

An arrangement provides an apparatus comprising: at least one processor; and
at least one memory storing instructions that when executed by the at least one processor cause the apparatus at least to perform:
receiving signals, from a network node, across a frequency range in a first mode, the frequency range containing at least two non-contiguous frequency blocks containing wanted signals for receiving signals transmitted by the network node, the at least two non-contiguous frequency blocks being separated by at least one frequency block in which unwanted signals to the apparatus may be transmitted; the apparatus being configured in the first mode to use at least two receive branches configured to receive signals across the first frequency range;
receiving signals, from the network node, across the frequency range in a second mode, the frequency range; the apparatus being configured in the second mode to use one receive branch of the at least two receive branches to receive a first frequency block of the at least two non-contiguous frequency blocks containing a wanted signal and suppress reception of a signal in the at least one frequency block in which unwanted signals to the apparatus may be transmitted; and another of the receive branches of at least two receive branches to receive a different frequency block of the at least two non-contiguous frequency blocks containing a wanted signal and suppress reception of a signal in the at least one frequency block in which unwanted signals to the apparatus may be transmitted;
determining an indication that the apparatus is to change between the first mode and the second mode; and
adjusting the apparatus between the first mode and the second mode in response to determining the indication that the apparatus is to change between modes.

In this way, if desired signals from a network node are subject to interference as a result of unwanted signals being transmitted within the at least one frequency block not containing signals transmitted by the network node, the apparatus, for example, user equipment or smart phone, may be adjusted from the first mode to the second mode such that the apparatus can mitigate interference caused by the unwanted signals. It will be appreciated that there is a trade-off between using two or more available receive branches to receive in the same frequency range and therefore allow an apparatus to benefit from diversity gain, and choosing to benefit from mitigating consequences of interference caused by the unwanted signals to signals that are desired.

In other words, arrangements may be such that receive branches provided at an apparatus move between: a first mode in which they are each configured to extract the same broad frequency section which spans the frequency range and a second mode in which the receive branches are configured to extract different frequency sections within the frequency range. According to some arrangements, an indication is used as a trigger to alter operation of the apparatus between first and second modes. That indication may relate, in some implementations, to a determined level of in-gap interference. The indication obtained determines how an apparatus will configure, for example, a diversity receive branch. In some particular implementations, in the first mode, the at least two receive branches may be configured to use the same local oscillator centre frequency and implement a broad bandwidth of the channel filter. In some particular implementations, in the second mode, the at least two receive branches may be configured to have different local oscillator frequencies and the receive branches may each implement a narrower bandwidth of the channel filter. The narrower bandwidths of the second mode may lie within the broader bandwidth of the first mode.

According to some arrangements, a receiver branch may be considered to comprise circuitry from an antenna through components for down-conversion of a radio signal received at the antenna. Such components may comprise, for example: switches, filters, low noise amplifiers, adjustable gain amplifiers, mixers supported by local oscillators, filters of adjustable bandwidth and analogue-to-digital converters.

A receiver branch may be considered to be an element of a communication network configured to receive and process an incoming signal or data stream. The receive branch is typically responsible for decoding, demodulating, and extracting transmitted information from a received signal.

In some arrangements, a receiver branch comprises an antenna and circuitry including RF components that process incoming signals or data. The receiver branch is responsible for decoding, demodulating, and extracting the transmitted information from the received signals.

As used here, a frequency range is a frequency interval defined between two frequency values. The frequency range may comprise one or more frequency blocks. Multiple frequency blocks are contiguous if they are arranged ‘end-to-end’ such that they form a continuous set of frequency resources. Frequency blocks are non-contiguous if they are not arranged ‘end-to-end’. For example, non-contiguous blocks for signals transmitted by a network node may be separated by a frequency block operated by a different operator. The non-contiguous frequency blocks and the frequency block operated by a different operator may all be contained within a frequency range.

In some arrangements, the at least one frequency block containing unwanted signals may contain signals not transmitted by the network node. In particular, in some arrangements, the at least one frequency block containing unwanted signals may contain signals transmitted by a different network node, or a network node belonging to a different network operator. In some arrangements, the at least one frequency block not containing signals transmitted by the network node can contain unwanted signals. In some arrangements, the at least one frequency block containing unwanted signals is reserved for, or assigned to, unwanted signals. In some arrangements, the at least one frequency block containing unwanted signals is occupied by signals from network nodes operated by one or more different operators to the at least one frequency block for containing signals transmitted by the network node. In some arrangements, the at least one frequency block containing unwanted signals comprises a set of frequency resources in which the network node is not assigned carriers.

In some arrangements, more than one receive antenna is provided at the apparatus. The receive antenna provided at an apparatus may be configured, in the first mode, to support diversity and MIMO techniques in a wireless communication network. Example arrangements recognise that an apparatus may be reconfigurable to a second mode which allows alternative uses of any second, or non-primary, receive antenna already provided as part of the apparatus. In such a second configuration a primary receive branch can be reconfigured to receive a first frequency block of a non-contiguous set of frequency blocks, and a diversity receive branch(s) can be reconfigured to receive other frequency block(s) of a non-contiguous set of frequency blocks.

As described in relation to further example embodiments below, determining the indication may include: determining at the apparatus autonomously that a criterion or threshold condition has been met based on measurements taken and/or estimates made by the apparatus; the indication may be used as a trigger that the apparatus is to change between the first mode and second modes.

In some arrangements, adjusting the apparatus between the first mode and the second mode comprises:
adjusting a filter bandwidth of one of the at least two receive branches between:
   a state in which signals received across the frequency range are passed and a further state in which signals received within the first frequency block containing a wanted signal of the at least two non-contiguous frequency blocks are passed; and
adjusting a filter bandwidth of another of the at least two receive branches between:
   a state in which signals received across the frequency range are passed and a further state in which signals received within the different frequency block containing a wanted signal of the at least two non-contiguous frequency blocks are passed.

In some arrangements, adjusting at least one filter(s) may be implemented using an adjustable bandpass filter. Alternatively, this may be implemented using an adjustable low-pass filter.

By adjusting the filter associated with a receive branch, it is possible to supress undesired signals. In particular, the first mode may allow a primary and at least one other receive branch to use a broad spectrum filter and receive across the entire of a broad frequency range. The filters for the primary and at least one other receive branch may, in the first mode, comprise corresponding filters having substantially the same range. In the second mode, the filter of the primary receive branch and at least one other receive branch may differ, so that a different region of the frequency range is selected by each of the primary receive branch and another receive branch.

In some arrangements, adjusting the apparatus between the first mode and the second mode comprises:
adjusting a local oscillator of one of the at least two receive branches between:
   a state in which signals received across the frequency range are passed for down-conversion and a further state in which signals received within the first frequency block of the at least two non-contiguous frequency blocks are passed for down-conversion; and
adjusting a local oscillator of another of the at least two receive branches between:
   a state in which signals received across the frequency range are passed for down-conversion and a further state in which signals received within the different frequency block of the at least two non-contiguous frequency blocks are passed for down-conversion.

In some embodiments, a local oscillator (LO) or numerically controlled oscillator (NCO) frequency may be shifted to provide adjustment between the first and second modes at each receive branch.

In some arrangements, adjusting the apparatus between the first and second modes comprises:
adjusting a filter bandwidth of one or more of the at least two receive branches between:
a state in which the filter of the at least two receive branches is substantially identical and configured to pass signals across the entire frequency range and suppress those signals outside the frequency range; and
a state in which the filter of the at least two receive branches is selected based upon the bandwidth of the first frequency block of the at least two non-contiguous frequency blocks; and the filter of another of the receive branches is selected based upon the bandwidth of a different frequency block of the at least two non-contiguous frequency blocks.

In some arrangements, in the first mode a primary receive branch and at least one additional receive branch implement a filter bandwidth according to which signals received within the frequency range are passed substantially identically by the primary receive branch and at least one additional receive branch, and wherein when in the second mode, the primary receive branch implements a filter bandwidth centred by the local oscillator of the primary receive branch upon one of the at least two non-contiguous frequency blocks and the at least one additional receive branch implements a filter bandwidth centred by the local oscillator of the additional receive branch upon a different one of the at least two non-contiguous frequency blocks.

In some arrangements, the at least two receive branches comprise: a primary receive branch and at least one diversity receive branch. In some arrangements, the at least two receive branches comprise diversity receive branches.

According to some arrangements, the first mode configures the apparatus to receive signals in the frequency range to support diversity reception techniques.

According to some arrangements, the second mode configures the apparatus to sacrifice reception of signals in the frequency range in a manner which supports diversity reception techniques.

According to some arrangements, the second mode configures the apparatus to abandon simultaneous reception of signals in the frequency range in a manner which supports diversity or MIMO reception techniques.

According to some arrangements, the first mode configures the apparatus to receive signals in a broader frequency block spanning the frequency range and the second mode configures the apparatus to receive signals in one or more narrower frequency blocks within the frequency range.

According to some arrangements, the apparatus is further caused to perform:
determining an indication of a received signal level of signals within the frequency range.

The received signal level(s) may provide an indication of an interference level caused by unwanted signals between the wanted non-contiguous frequency blocks in which there are signals from the network node.

The determined indications of received signal level(s) may include an indication of a signal level within the one or more unwanted signal frequency blocks. In other words, a signal level in frequency blocks not containing signals transmitted by the network node. Additionally, the signal level may include a signal level within one or more of the at least one frequency block for containing signals transmitted by the network node. In other words, indications of more than one signal level may be determined such that a signal level within both the at least one frequency block for containing signals transmitted by the network node and the at least one frequency block not containing signals transmitted by the network node may be monitored. In some arrangements, a plurality of indications of a signal level are determined.

The apparatus (for example, a UE) may obtain information about which signal level measurements to perform from the network node, or may be preconfigured with information relating to signal level measurements to perform in the event of non-contiguous frequency block reception. The information may relate to: the frequency range; and/or the at least one frequency block for containing signals transmitted by the network node; and/or the at least one frequency block containing unwanted signals.

The apparatus, for example, UE, may make a signal level measurement at least in a frequency block in which a wanted signal is expected, and a frequency block in which an unwanted signal may be transmitted.

Accordingly, the at least one (unwanted) frequency block not containing signals transmitted by the network node may be included in received signal level measurements. Depending on what the UE measures a comparison of wanted to unwanted signal reception levels can be performed at the UE. In other words, the apparatus, for example UE or smartphone, may be configured to perform an assessment of a level of wanted signal to in-gap interference being experienced and to take action accordingly.

An indication of a received signal level may comprise an indication of at least one of the following: power, power spectral density (PSD), received signal strength indication (RSSI), reference signal received power (RSRP) and reference signal received quality (RSRQ).

In some arrangements, the apparatus is further caused to perform: evaluating an indication of interference caused by the unwanted signals transmitted in the at least one frequency block in which unwanted signals may be transmitted together with the at least two non-contiguous frequency blocks for receiving signals transmitted by the network node, based upon the determined indication of the received signal level of signals within the frequency range.

Autonomous operation of the apparatus to assess whether to move between the first and second modes may be preferred. The apparatus (for example, UE) supports a UE-centric approach, allowing the UE to take dynamic action in response to conditions being experienced by the UE.

In some arrangements, determining the indication that the apparatus is to change between the first mode and the second mode comprises: determining that a criterion relating to the evaluated indication of interference or the determined indication of the received signal level of signals within the frequency range has been met.

According to some arrangements, the apparatus may autonomously determine that it should swap between the first mode and the second mode based on a criterion. The criterion may relate an assessment of signal level, and in particular to assessing whether there is an unacceptable level of interference originating from the at least one frequency block not containing signals transmitted by the network node.

The criterion may comprise a predetermined threshold. The threshold may relate to whether the in-gap interference is at an acceptable or unacceptable level. The acceptable threshold may be selected based upon whether signal(s) transmitted in the at least two non-contiguous frequency blocks are generally decodable by the apparatus. Accordingly, the threshold may depend upon the received signal level in the at least two non-contiguous frequency blocks compared to the signal level/interference level at the apparatus in the at least one frequency block in which unwanted signals may be transmitted.

In some arrangements, the apparatus is further caused to perform: determining an indication that the apparatus is to change from the second mode to the first mode; and adjusting the apparatus from the second mode to the first mode in response to determining the indication that the apparatus is to change from the second mode to the first mode.

The teachings which relate to the adjustment of the apparatus from the first mode to the second mode may generally also be applicable to the adjustment of the apparatus from the second mode to the first mode. For example, the decision to change from the second mode to the first mode may be made autonomously by the apparatus. In some example arrangements, the decision to change from the second mode to the first mode may be based on a determination by the apparatus that a criterion has been met. The criterion may relate to assessing when there is likely to be an acceptable or tolerable level of interference originating from the unwanted signal in at least one frequency block not containing signals transmitted by the network node.

According to some, but not necessarily all, arrangements, there is provided a method performed by user equipment, the method comprising:
receiving signals, from a network node, across a frequency range in a first mode, the frequency range containing at least two non-contiguous frequency blocks for receiving signals transmitted by the network node, the at least two non-contiguous frequency blocks being separated by at least one frequency block in which unwanted signals may be transmitted; the apparatus being configured in the first mode to use at least two receive branches configured to receive signals across the first frequency range;
receiving signals, from the network node, across the frequency range in a second mode, the frequency range; the apparatus being configured in the second mode to use one receive branch of the at least two receive branches to receive a first frequency block of the at least two non-contiguous frequency blocks and suppress reception of a signal in the at least one frequency block in which unwanted signals may be transmitted; and another of the receive branches of at least two receive branches to receive a different frequency block of the at least two non-contiguous frequency blocks and suppress reception of a signal in the at least one frequency block in which unwanted signals may be transmitted;
determining an indication that the apparatus is to change between the first mode and the second mode; and
adjusting the apparatus between the first mode and the second mode in response to determining the indication that the apparatus is to change between the first mode and the second mode.

In some arrangements, adjusting the apparatus between the first mode and the second mode comprises:
adjusting a filter bandwidth of one of the at least two receive branches between:
a state in which signals received across the frequency range are passed and a further state in which signals received within the first frequency block containing a wanted signal of the at least two non-contiguous frequency blocks are passed; and
adjusting a filter bandwidth of another of the at least two receive branches between:
a state in which signals received across the frequency range are passed and a further state in which signals received within the different frequency block containing a wanted signal of the at least two non-contiguous frequency blocks are passed.

In some arrangements, adjusting the apparatus between the first mode and the second mode comprises:
adjusting a local oscillator of one of the at least two receive branches between:
a state in which signals received across the frequency range are passed for down-conversion and a further state in which signals received within the first frequency block of the at least two non-contiguous frequency blocks are passed for down-conversion; and
adjusting a local oscillator of another of the at least two receive branches between:
a state in which signals received across the frequency range are passed for down-conversion and a further state in which signals received within the different frequency block of the at least two non-contiguous frequency blocks are passed for down-conversion.

In some arrangements, adjusting the apparatus between the first and second modes comprises:
adjusting a filter bandwidth of one or more of the at least two receive branches between:
a state in which the filter of the at least two receive branches is substantially identical and configured to pass signals across the entire frequency range and suppress those signals outside the frequency range; and
a state in which the filter of the at least two receive branches is selected based upon the bandwidth of the first frequency block of the at least two non-contiguous frequency blocks; and the filter of another of the receive branches is selected based upon the bandwidth of a different frequency block of the at least two non-contiguous frequency blocks.

According to some arrangements, in the first mode a primary receive branch and at least one additional receive branch implement a filter bandwidth according to which signals received within the frequency range are passed substantially identically by the primary receive branch and at least one additional receive branch, and wherein when in the second mode, the primary receive branch implements a filter bandwidth centred by the local oscillator of the primary receive branch upon one of the at least two non-contiguous frequency blocks and the at least one additional receive branch implements a filter bandwidth centred by the local oscillator of the additional receive branch upon a different one of the at least two non-contiguous frequency blocks.

According to some arrangements, the first mode comprises receiving signals in the frequency range to support diversity and/or MIMO reception techniques.

According to some arrangements, the second mode comprises abandoning simultaneous reception of signals in the frequency range in a manner which supports diversity or MIMO reception techniques.

According to some arrangements, the first mode comprises receiving signals in a broader frequency block spanning the frequency range and the second mode comprises receiving signals in one or more narrower frequency blocks within the frequency range.

According to some arrangements, the method comprises determining an indication of a received signal level of signals within the frequency range.

According to some arrangements, determining an indication of a received signal level of signals within the frequency range comprises:
determining an indication of signal level of unwanted signals transmitted in the at least one frequency block in which unwanted signals may be transmitted; and
determining an indication of signal level of wanted signal in at least one of the two non-contiguous frequency blocks for receiving wanted signals transmitted by the network node.

According to some arrangements, the method comprises:
evaluating a ratio of:
(i) interference caused by the unwanted signals transmitted in the at least one frequency block in which unwanted signals may be transmitted; and
(ii) wanted signal in the at least two non-contiguous frequency blocks for receiving wanted signals transmitted by the network node,
the evaluated ratio being based upon a determined indication of received signal level of at least two signals within the frequency range.

According to some arrangements, determining the indication that the apparatus is to change between the first mode and the second mode comprises:
determining that a criterion relating to a ratio of wanted signal to interference within the frequency range has been met.

According to some arrangements, the method comprises: determining an indication that the apparatus is to change between the second mode and the first mode; and adjusting the apparatus from the second mode to the first mode in response to determining the indication that the apparatus is to change from the second mode to the first mode.

According to some, but not necessarily all, arrangements, there is provided a computer program comprising instructions which, when executed by an apparatus, cause the apparatus to perform at least the following:
receiving signals, from a network node, across a frequency range in a first mode, the frequency range containing at least two non-contiguous frequency blocks for receiving signals transmitted by the network node, the at least two non-contiguous frequency blocks being separated by at least one frequency block in which unwanted signals may be transmitted; the apparatus being configured in the first mode to use at least two receive branches configured to receive signals across the first frequency range;
receiving signals, from the network node, across the frequency range in a second mode, the frequency range; the apparatus being configured in the second mode to use one receive branch of the at least two receive branches to receive a first frequency block of the at least two non-contiguous frequency blocks and suppress reception of a signal in the at least one frequency block in which unwanted signals may be transmitted; and another of the receive branches of at least two receive branches to receive a different frequency block of the at least two non-contiguous frequency blocks and suppress reception of a signal in the at least one frequency block in which unwanted signals may be transmitted;
determining an indication that the apparatus is to change between the first mode and the second mode; and
adjusting the apparatus between the first mode and the second mode in response to determining the indication that the apparatus is to change between the first mode and the second mode.

Having described various arrangements in general, further embodiments and arrangements are discussed in detail below in relation to the specific scenarios.

### Non-Contiguous Spectrum

The 3rd Generation Partnership Project (3GPP) categorizes carrier aggregation in three different categories:
1. Intra-band contiguous spectrum: where the multiple carriers (frequency blocks or sub-blocks) are adjacent to each other in frequency and can be received with a single receiver.
2. Intra-band non-contiguous spectrum: where the multiple carriers (frequency blocks) are within the same frequency band, but not adjacent to each other. Another operator may occupy a spectrum block in between the aggregated component carriers.
3. Inter-band: where the multiple carriers aggregated belong to different frequency bands.

Intra-band carrier aggregation can be advantageous to the UE radio frequency (RF) architecture if the summed bandwidth of the adjacent carriers is within the capabilities of the receiver. In this case, it may be possible to receive signals over all the carriers with a single receiver (Rx) branch. The component blocks of a typical receiver branch are defined as:
Band filter: A fixed analogue RF filter that passes through a full bandwidth of one frequency band.
LNA: A fixed-gain Low-Noise Amplifier.
Channel filter: A configurable analogue filter that passes through the wanted carrier (i.e. spectrum block) of the band after down-conversion.
VGA: Variable Gain Amplifier that Automatic Gain Control loop adjusts to maintain the ADC input at a wanted level suitable for the ADC output to represent the wanted signal with the full dynamic range of the ADC.
ADC: Analogue-to-Digital Converter.

The use of such a single receiver branch may allow the UE RF architecture in which separate RF blocks are used for non-contiguous carriers instead to use the separate receive branch for a different purpose, such as inter-band carrier aggregation.

The spectrum holdings of the different operators are in most cases the result of auctions held by national spectrum regulators. These auctions are highly competitive and the resulting spectrum blocks licensed to different operators may not always be the most efficient. For example, the spectrum blocks may be distributed. In other words, the spectrum blocks may be non-adjacent or non-contiguous across the frequency band and/or not devisable with the available LTE/NR channel bandwidths. In TS 38.101-1 clause 5.4.1, the nominal channel spacing is defined and in clause 5.4A.1 it is specified that all carrier aggregations between two NR component carriers in different sub-blocks larger than the nominal channel spacing shall be treated as intra-band non-contiguous carrier aggregation. In some cases, the national regulators encourage the operators to swap spectrum among themselves to overcome potential issues. However, many operators refuse to swap any spectrum possibly to avoid any competitor gaining an advantage. As a result, the operators need to consider mechanisms which enable use of non-contiguous carrier aggregation to efficiently utilize their spectrum.

Intra-band non-contiguous carrier aggregation has the drawback that in order to guarantee protection against interference from signals within the unwanted spectrum block between the two wanted spectrum blocks, it may be necessary to receive the two wanted spectrum blocks separately. Hence, duplication of some hardware blocks in the UE receiver may be required adding to the complexity and resources required in the UE RF architecture.

The conventional approach for dealing with non-contiguous carrier aggregation uses a double or split receiver branch.

Each frequency block (or each contiguous set of frequency blocks) within the non-contiguous aggregated carriers takes up one Rx branch within the UE. If there are multiple intervening frequency blocks licensed to other operators, a separate receiving branch would be required for each contiguous section of the operator's licensed spectrum. Therefore, there is a practical restriction on the maximum number of aggregated frequency blocks based on the receiver branch of a UE using this approach. As a result, at present, operators may be limited in their use of their licensed spectrum based on what the UEs in the market/field can support. Naturally, UE vendors would prefer to keep complexity and costs down so it would be beneficial if the UE could handle non-contiguous carrier aggregation without needing significant hardware changes.

FIG. 1 illustrates relaxation of an in-gap interferers level signal level. If operating in a non-contiguous spectrum regime, it is typically not possible for a UE to suppress in-gap interference if the UE uses a wider analogue channel bandwidth for receiving both spectrum sub-blocks (each sub-block contains one or more CCs) and use Carrier Aggregation communication techniques. In particular, any suppression a typical analogue filter is configured to apply to “adjacent” channels is no longer available. As a result, a UE may need to cope with a stronger level of what would otherwise be considered “in band” interference. Since a UE has no means to suppress the interference, a relaxation of usual signal to interference parameters requires for operation in a network can be agreed for the case in which the UE is operating in a non-contiguous spectrum regime. In particular, a different, less stringent level of signal to noise ratio is applied in relation to an in-gap interferers signal level compared to the UE signal level. In such a scenario, however, the UE may be able to measure, for example, power of received signal of in relation to the in-gap interferer since no attenuation of that signal is being applied. A UE operating in such a regime may therefore be able to determine accurately a “desired signal”-to-in-gap interference ratio (SIG).

According to some arrangements, for example, when a UE has received a Radio Resource Control (RRC) configuration or reconfiguration message which contains an appropriate carrier aggregation (CA) configuration of non-contiguous intra-band CA, including combinations of the same with an interband, then the UE may be configured to use the SIG as a parameter to determine whether interference caused by a non-contiguous regime is at a tolerable or intolerable level, and, based upon such a determination, a UE according to arrangement may be configured to select an appropriate front-end configuration to support same or split frequency operation on a main and diversity receive branch.

FIG. 2 illustrates schematically a typical UE radio frequency (RF) architecture. The UE RF architecture shown in FIG. 4 is such that a system comprises front-end components for a main and at least one diversity receiver.

It can be seen in FIG. 2 that a UE may be configured, according to such architecture, to route uplink (Transmissions—TX) to a diversity module for Sounding Reference Signal (SRS) switching or for best antenna transmission. Receive (RX) branches supporting Non-Contiguous Intra-band Carrier Aggregation (NC IB CA) have a mechanism such that a UE can split a received signal towards two down-conversion paths. Typically the down conversion frequency of the main and diversity receiver(s), as set by the local oscillators (LO) are the same, allowing the UE to use signal diversity methods to decode a received signal. Arrangements recognise that by offsetting a down conversion frequency (LO) between a main and one or more diversity receive paths, a UE may centre down conversion according to a centre frequency and bandwidth selected in relation to each of the non-contiguous component carrier (CC) band shown schematically in FIG. 1. Such splitting of the received signal and off-setting of the local oscillator(s) for the main and diversity receive branches may allow a UE to effectively suppress an in-gap interferer.

FIG. 3 is a simplified schematic illustration of a UE radio frequency architecture according to an arrangement. As shown in FIG. 3, arrangements in accordance with described approaches and methodologies may be supported if, for example, adjustable or additional Local Oscillators (LOs) are added to typical standard UE RF receive hardware. Such addition of a functionality allowing readjustment of receive branches provided at a UE may allow a UE to configure the radio portion of receive operation to support improved reception performance. By comparing FIG. 3 and FIG. 2 it can be seen that the receiver branches have been reduced, allowing the receiver branches still present in the UE hardware of FIG. 2 to serve a different purpose than support for non-contiguous intra-band CA.

FIG. 4 is a graphic illustration of reception at baseband frequency at a UE configured to receive signals and benefit from diversity reception techniques whilst a signal-to-in-gap interference ratio (SIG) is determined to be below a threshold. In a state of low in-gap interference, for example as detected by the UE in a NC IB CA configuration, the UE may be configured to implement a receive regime in which the frequency of the main and diversity receiver(s) are aligned, for example, LO1=LO2. Such a configuration makes down-conversion of a received signal equal from both the main and the diversity branch as indicated schematically in FIG. 4. In the arrangement illustrated in FIG. 4, it may be understood that either receive branch, and in this particular case, the diversity receive branch may have a slightly better propagation path indicated by higher power levels of all received signals (CC1, CC2 and the in-gap interference).

FIG. 5 is a graphic illustration of reception at baseband frequency at a UE configured to use split local oscillator frequency assignment when a signal-to-in-gap interference ratio (SIG) is determined to be above a predetermined threshold. As a signal-to-in-gap interference ratio (SIG) associated with received signals at a UE moves past a preselected threshold level, the UE in accordance with arrangements may be operable to reconfigure a centre frequency of local oscillators (LOs) of the main and diversity receiver(s) such that LO1≠LO2. Such an approach supports use of analogue channel filters matching a dedicated CC's bandwidth. FIG. 7 is a schematic representation of how such a configuration could support suppression of in-gap interference.

FIG. 6 illustrates schematically an apparatus according to an arrangement. FIG. 6 shows an apparatus, for example, a UE, 8000, comprising:
circuitry 8100 configured to receive signals, from a network node, across a frequency range in a first mode, the frequency range containing at least two non-contiguous frequency blocks for receiving signals transmitted by the network node, the at least two non-contiguous frequency blocks being separated by at least one frequency block in which unwanted signals may be transmitted; the apparatus being configured in the first mode to use at least two receive branches configured to receive signals across the first frequency range;
   circuitry 8200 configured to receive signals, from the network node, across the frequency range in a second mode, the frequency range; the apparatus being configured in the second mode to use one receive branch of the at least two receive branches to receive a first frequency block of the at least two non-contiguous frequency blocks and suppress reception of a signal in the at least one frequency block in which unwanted signals may be transmitted; and another of the receive branches of at least two receive branches to receive a different frequency block of the at least two non-contiguous frequency blocks and suppress reception of a signal in the at least one frequency block in which unwanted signals may be transmitted;
circuitry 8300 configured to determine an indication that the apparatus is to change between the first mode and the second mode; and
circuitry 8400 configured to adjust the apparatus between the first mode and the second mode in response to determining the indication that the apparatus is to change between the first mode and the second mode.

FIG. 7 illustrates schematically a method according to an arrangement which may be performed by user equipment such as that shown in FIG. 6. The method shown in FIG. 7 comprises the steps of:
determining 9100 an indication that the apparatus is to change between a first mode and a second mode; and
adjusting 9200 the apparatus between the first mode and the second mode in response to determining the indication that the apparatus is to change between the first mode and the second mode and
receiving signals 9300, from a network node, across a frequency range in the first mode, the frequency range containing at least two non-contiguous frequency blocks for receiving signals transmitted by the network node, the at least two non-contiguous frequency blocks being separated by at least one frequency block in which unwanted signals may be transmitted; the apparatus being configured in the first mode to use at least two receive branches configured to receive signals across the first frequency range; or
receiving signals 9400, from the network node, across the frequency range in the second mode, the frequency range; the apparatus being configured in the second mode to use one receive branch of the at least two receive branches to receive a first frequency block of the at least two non-contiguous frequency blocks and suppress reception of a signal in the at least one frequency block in which unwanted signals may be transmitted; and another of the receive branches of at least two receive branches to receive a different frequency block of the at least two non-contiguous frequency blocks and suppress reception of a signal in the at least one frequency block in which unwanted signals may be transmitted

[symbol]

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The tern non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The ordering of method steps set out above may not be critical or fixed and the exact ordering of the steps may be varied as appropriate.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-15. (canceled)

16. An apparatus comprising:
at least one processor; and
at least one memory storing instructions that when executed by the at least one processor cause the apparatus at least to perform:
receiving signals, from a network node, across a frequency range in a first mode, the frequency range containing at least two non-contiguous frequency blocks containing wanted signals for receiving signals transmitted by the network node, the at least two non-contiguous frequency blocks being separated by at least one frequency block in which unwanted signals to the apparatus may be transmitted; the apparatus being configured in the first mode to use at least two receive branches configured to receive signals across the first frequency range;
receiving signals, from the network node, across the frequency range in a second mode; the apparatus being configured in the second mode to use one receive branch of the at least two receive branches to receive a first frequency block of the at least two non-contiguous frequency blocks containing a wanted signal and suppress reception of a signal in the at least one frequency block in which unwanted signals to the apparatus may be transmitted; and another of the receive branches of at least two receive branches to receive a different frequency block of the at least two non-contiguous frequency blocks containing a wanted signal and suppress reception of a signal in the at least one frequency block in which unwanted signals to the apparatus may be transmitted;
determining an indication that the apparatus is to change between the first mode and the second mode; and
adjusting the apparatus between the first mode and the second mode in response to determining the indication that the apparatus is to change between modes.

17. The apparatus according to claim 16, wherein the adjusting the apparatus between the first mode and the second mode comprises:
adjusting a filter bandwidth of one of the at least two receive branches between,
a state in which signals received across the frequency range are passed and
a further state in which signals received within the first frequency block containing a wanted signal of the at least two non-contiguous frequency blocks are passed; and
adjusting a filter bandwidth of another of the at least two receive branches between,
a state in which signals received across the frequency range are passed and a further state in which signals received within the different frequency block containing a wanted signal of the at least two non-contiguous frequency blocks are passed.

18. The apparatus according to claim 16, wherein the adjusting the apparatus between the first mode and the second mode comprises:
adjusting a local oscillator of one of the at least two receive branches between,
a state in which signals received across the frequency range are passed for down-conversion and a further state in which signals received within the first frequency block of the at least two non-contiguous frequency blocks are passed for down-conversion; and
adjusting a local oscillator of another of the at least two receive branches between,
a state in which signals received across the frequency range are passed for down-conversion and a further state in which signals received within the different frequency block of the at least two non-contiguous frequency blocks are passed for down-conversion.

19. The apparatus according to claim 16, wherein the adjusting the apparatus between the first and second modes comprises:
adjusting a filter bandwidth of one or more of the at least two receive branches between,
a state in which the filter of the at least two receive branches is substantially identical and configured to pass signals across the entire frequency range and suppress those signals outside the frequency range; and
a state in which the filter of the at least two receive branches is selected based upon the bandwidth of the first frequency block of the at least two non-contiguous frequency blocks; and the filter of another of the receive branches is selected based upon the bandwidth of a different frequency block of the at least two non-contiguous frequency blocks.

20. The apparatus according to claim 19, wherein in the first mode a primary receive branch and at least one additional receive branch implement a filter bandwidth according to which signals received within the frequency range are passed substantially identically by the primary receive branch and at least one additional receive branch, and wherein when in the second mode, the primary receive branch implements a filter bandwidth centred by the local oscillator of the primary receive branch upon one of the at least two non-contiguous frequency blocks and the at least one additional receive branch implements a filter bandwidth centred by the local oscillator of the additional receive branch upon a different one of the at least two non-contiguous frequency blocks.

21. The apparatus according to claim 16, wherein the first mode configures the apparatus to receive signals in the frequency range to support diversity and/or MIMO reception techniques.

22. The apparatus according to claim 16, wherein the second mode configures the apparatus to abandon simultaneous reception of signals in the frequency range in a manner which supports diversity or MIMO reception techniques.

23. The apparatus according to claim 16, wherein the first mode configures the apparatus to receive signals in a broader frequency block spanning the frequency range and the second mode configures the apparatus to receive signals in one or more narrower frequency blocks within the frequency range.

24. The apparatus according to claim 16, wherein the apparatus is further caused to perform:
determining an indication of a received signal level of signals within the frequency range.

25. The apparatus according to claim 24, wherein the determining an indication of a received signal level of signals within the frequency range comprises:
determining an indication of signal level of unwanted signals transmitted in the at least one frequency block in which unwanted signals may be transmitted; and
determining an indication of signal level of wanted signal in at least one of the two non-contiguous frequency blocks for receiving wanted signals transmitted by the network node.

26. The apparatus according to claim 24, wherein the apparatus is further caused to perform:
evaluating a ratio of,
(i) interference caused by the unwanted signals transmitted in the at least one frequency block in which unwanted signals may be transmitted; and
(ii) wanted signal in the at least two non-contiguous frequency blocks for receiving wanted signals transmitted by the network node,
the evaluated ratio being based upon a determined indication of received signal level of at least two signals within the frequency range.

27. The apparatus according to claim 24, wherein the determining the indication that the apparatus is to change between the first mode and the second mode comprises:
determining that a criterion relating to a ratio of wanted signal to interference within the frequency range has been met.

28. The apparatus according to claim 16, wherein the apparatus is further caused to perform:
determining an indication that the apparatus is to change between the second mode and the first mode; and adjusting the apparatus from the second mode to the first mode in response to determining the indication that the apparatus is to change from the second mode to the first mode.

29. The apparatus according to claim 16, wherein the apparatus comprises a user equipment.

30. A method performed by user equipment, the method comprising:
receiving signals, from a network node at a user equipment, across a frequency range in a first mode, the frequency range containing at least two non-contiguous frequency blocks for receiving signals transmitted by the network node, the at least two non-contiguous frequency blocks being separated by at least one frequency block in which unwanted signals may be transmitted; the user equipment being configured in the first mode to use at least two receive branches configured to receive signals across the first frequency range;
receiving signals, from the network node at the user equipment, across the frequency range in a second mode; the user equipment being configured in the second mode to use one receive branch of the at least two receive branches to receive a first frequency block of the at least two non-contiguous frequency blocks and suppress reception of a signal in the at least one frequency block in which unwanted signals may be transmitted; and another of the receive branches of at least two receive branches to receive a different frequency block of the at least two non-contiguous frequency blocks and suppress reception of a signal in the at least one frequency block in which unwanted signals may be transmitted;
determining an indication that the user equipment is to change between the first mode and the second mode; and
adjusting the user equipment between the first mode and the second mode in response to determining the indication that the user equipment is to change between the first mode and the second mode.

31. The method according to claim 30, wherein the adjusting the user equipment between the first mode and the second mode comprises:
adjusting a filter bandwidth of one of the at least two receive branches between,
a state in which signals received across the frequency range are passed and
a further state in which signals received within the first frequency block containing a wanted signal of the at least two non-contiguous frequency blocks are passed; and
adjusting a filter bandwidth of another of the at least two receive branches between,
a state in which signals received across the frequency range are passed and a further state in which signals received within the different frequency block containing a wanted signal of the at least two non-contiguous frequency blocks are passed.

32. The method according to claim 30, wherein the adjusting the user equipment between the first mode and the second mode comprises:
adjusting a local oscillator of one of the at least two receive branches between,
a state in which signals received across the frequency range are passed for down-conversion and a further state in which signals received within the first frequency block of the at least two non-contiguous frequency blocks are passed for down-conversion; and
adjusting a local oscillator of another of the at least two receive branches between,
a state in which signals received across the frequency range are passed for down-conversion and a further state in which signals received within the different frequency block of the at least two non-contiguous frequency blocks are passed for down-conversion.

33. The method according to claim 30, wherein the adjusting the user equipment between the first and second modes comprises:
adjusting a filter bandwidth of one or more of the at least two receive branches between,
a state in which the filter of the at least two receive branches is substantially identical and configured to pass signals across the entire frequency range and suppress those signals outside the frequency range; and
a state in which the filter of the at least two receive branches is selected based upon the bandwidth of the first frequency block of the at least two non-contiguous frequency blocks; and the filter of another of the receive branches is selected based upon the bandwidth of a different frequency block of the at least two non-contiguous frequency blocks.

34. The method according to claim 30, wherein
the first mode configures the user equipment to receive signals in the frequency range to support diversity and/or MIMO reception techniques; and
the second mode configures the user equipment to abandon simultaneous reception of signals in the frequency range in a manner which supports diversity or MIMO reception techniques.

35. A non-transitory computer readable medium storing instructions which, when executed by an apparatus, cause the apparatus to perform at least the following:
receiving signals, from a network node, across a frequency range in a first mode, the frequency range containing at least two non-contiguous frequency blocks for receiving signals transmitted by the network node, the at least two non-contiguous frequency blocks being separated by at least one frequency block in which unwanted signals may be transmitted; the apparatus being configured in the first mode to use at least two receive branches configured to receive signals across the first frequency range;
receiving signals, from the network node, across the frequency range in a second mode; the apparatus being configured in the second mode to use one receive branch of the at least two receive branches to receive a first frequency block of the at least two non-contiguous frequency blocks and suppress reception of a signal in the at least one frequency block in which unwanted signals may be transmitted; and another of the receive branches of at least two receive branches to receive a different frequency block of the at least two non-contiguous frequency blocks and suppress reception of a signal in the at least one frequency block in which unwanted signals may be transmitted;
determining an indication that the apparatus is to change between the first mode and the second mode; and
adjusting the apparatus between the first mode and the second mode in response to determining the indication that the apparatus is to change between the first mode and the second mode.
